(19) United States
(12) Patent Application Publication
(10) Pub. No.: US 2026/0039022 A1
(43) Pub. Date: Feb. 5, 2026

(54) Variable Antenna for Near-Field Radio Devices

(71) Applicant: ZEBRA TECHNOLOGIES CORPORATION, Lincolnshire, IL (US)

(72) Inventors: Mark Duron, Mastic, NY (US); David Schmitt, Bolingbrook, IL (US); Dale Himmelspach, Antioch, IL (US)

(21) Appl. No.: 18/791,398

(22) Filed: Jul. 31, 2024

(51) Int. Cl. H01Q 9/14; H01Q 1/22

(52) U.S. Cl. CPC H01Q 9/14; H01Q 1/2208

(57) ABSTRACT

Variable antennas for near-field radio devices are provided herein. An example device includes an antenna, an electrical load electrically connected to the antenna, and a switching apparatus configured to vary an effective length of the antenna such that a standing wave propagating along the antenna is phase and position offset by a configurable amount when the switching apparatus is operated.

### BACKGROUND

When operating a device which communicates with other devices in a near-field region, an antenna is employed to facilitate communication. Enabling this communication typically involves applying an alternating voltage to the antenna, which results in a voltage standing wave which propagates along a length of the antenna. As is typical for standing waves, nodes will form periodically along the antenna where a voltage (and thus a resulting electric field surrounding the antenna) is effectively zero.

### SUMMARY

Variable antennas for near field radio devices are provided herein. In an example embodiment, a device comprises an antenna, an electrical load electrically connected to the antenna, and a switching apparatus configured to vary an effective length of the antenna such that a standing wave propagating along the antenna is phase and position offset by a configurable amount when the switching apparatus is operated.

In a variation of this example embodiment, the switching apparatus includes one or more paths to an electrical ground positioned at intervals along a length of the antenna on a side of the electrical load opposite to a source of the standing wave.

In a variation of this example embodiment, each of the one or more paths to the electrical ground includes a secondary electrical load.

In a variation of this example embodiment, a first secondary electrical load is configured with a different impedance than a second secondary electrical load.

In a variation of this example embodiment, the load is configured with a variable impedance.

In a variation of this example embodiment, the device is configured with a cyclical operation that includes an active period in which the standing wave is held constant and an inactive period in which an amplitude or phase of the standing wave is modified, and wherein the switching apparatus is configured to vary the effective length of the antenna during the inactive period.

In a variation of this example embodiment, the device is configured to extract data from one or more radio frequency identification (RFID) tags.

In a variation of this example embodiment, the device is configured to extract data from the one or more RFID tags at a distance equal to or less than 16% of a wavelength of the standing wave.

In a variation of this example embodiment, the device is configured to extract data from the one or more RFID tags at a distance greater than or equal to 16% of a wavelength of the standing wave.

In a variation of this example embodiment, the switching apparatus varies the effective length of the antenna such that a standing wave propagating along the antenna is phase and position offset such that points along the effective length of the antenna are subjected to an amplitude equal to or between a preselected minimum and maximum amplitude of the standing wave at least once during a full cycle of operation of the switching apparatus.

In a variation of this example embodiment, the switching apparatus includes at least one field effect transistor.

In another example embodiment, a method comprises applying an electrical signal to an electrically loaded antenna such that an electrical standing wave propagates along a length of the antenna, providing, via a switching apparatus, a first path to an electrical ground along an effective length of the antenna such that the standing wave propagates at a first phase and position, and providing, via the switching apparatus, a second path to the electrical ground along the effective length of the antenna such that the standing wave propagates at a second phase and position.

In a variation of this example embodiment, the first path to the electrical ground and the second path to the electrical ground are placed at a first location and a second location, respectively, along a length of the antenna on a side of the electrical load opposite to a source of the standing wave.

In a variation of this example embodiment, each of the first path to the electrical ground and the second path to the electrical ground includes a secondary electrical load.

In a variation of this example embodiment, a first secondary electrical load of the first path to the electrical ground is configured with a different impedance than a second secondary electrical load of the second path to the electrical ground.

In a variation of this example embodiment, the electrical load is configured with a variable impedance.

In a variation of this example embodiment, the method further comprises designating an active period of a cycle of operation of the antenna in which the standing wave is held constant and designating an inactive period of a cycle of operation of the antenna in which an amplitude or phase of the standing wave is modified, during which the switching apparatus is configured to vary the length of the antenna.

In a variation of this example embodiment, the method further comprises extracting data from one or more radio frequency identification (RFID) tags.

In a variation of this example embodiment, the method further comprises extracting data from the one or more RFID tags at a distance equal to or less than 16% of a wavelength of the standing wave.

In a variation of this example embodiment, the switching apparatus varies the effective length of the antenna such that a standing wave propagating along the antenna is phase and position offset such that points along the effective length of the antenna are subjected to an amplitude equal to or between a preselected minimum and maximum amplitude of the standing wave at least once during a full cycle of operation of the switching apparatus.

In a variation of this example embodiment, the switching apparatus includes at least one field effect transistor.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example antenna with a switching apparatus, according to example embodiments of the present disclosure.

FIG. 2 illustrates the example antenna and switching apparatus in a first state, according to example embodiments of the present disclosure.

FIG. 3 illustrates the example antenna and switching apparatus in a second state, according to example embodiments of the present disclosure.

FIG. 4 illustrates the example antenna and switching apparatus with a standing wave of a first voltage amplitude, according to example embodiments of the present disclosure.

FIG. 5 illustrates the example antenna and switching apparatus with a standing wave of a second voltage amplitude, according to example embodiments of the present disclosure.

FIG. 6 is a diagram which illustrates standing waves from FIG. 4 and FIG. 5 along with a superimposed composite wave, according to example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Devices and methods are provided herein for varying an antenna for near-field radio devices. When operating certain radio devices (e.g. a radio frequency identification (RFID) tag reader), it is desirable to limit a distance from an antenna at which a device, such as an RFID tag, will respond to a read request. Such operating characteristics prevent unwanted read events from tags located further away than intended, but these characteristics introduce design challenges with regard to reliability.

Detecting and reading a radio device typically requires that an alternating voltage at a particular frequency (associated with an expected device to be read) be applied to an antenna. This alternating voltage results in a standing wave along a length of the antenna and a corresponding alternating electric field which causes a response to be sent from radio devices which are close enough to the antenna. The standing wave, however, includes nodes spaced at half-wavelength intervals along the antenna at which a wave voltage (and thus an electric field voltage) is zero. These nodes result in “dead spots” along the length of the antenna where radio devices cannot be read due to a lack of electric field to cause a response to be sent. This effect can be mitigated by increasing an amplitude of the standing wave, thereby shrinking an effective size of the “dead spots”, but this causes the electric field to project farther and increases a risk of unwanted read events from radio devices outside of a near-field distance.

Devices and methods of the present disclosure seek to solve the problem associated with standing wave nodes by shifting the nodes periodically along the antenna. Positions of the nodes are determined by fundamental properties of the standing wave along with the length of the antenna, and so by periodically changing the length of the antenna one can shift the nodes so that no one position along the antenna is and remains a “dead spot” through a cycle of antenna lengths. This can be achieved by adding a switching apparatus to the end of the antenna such that paths to ground can be alternatively provided at varying positions, with switching changes occurring during a period of time between reading cycles where the antenna is inactive. Those of skill in the art will recognize that this solution also potentially allows for fine control of aspects of an antenna's projected field which are not practically achievable with conventional means such as dynamic control of field projection distance at varying locations along the antenna's length.

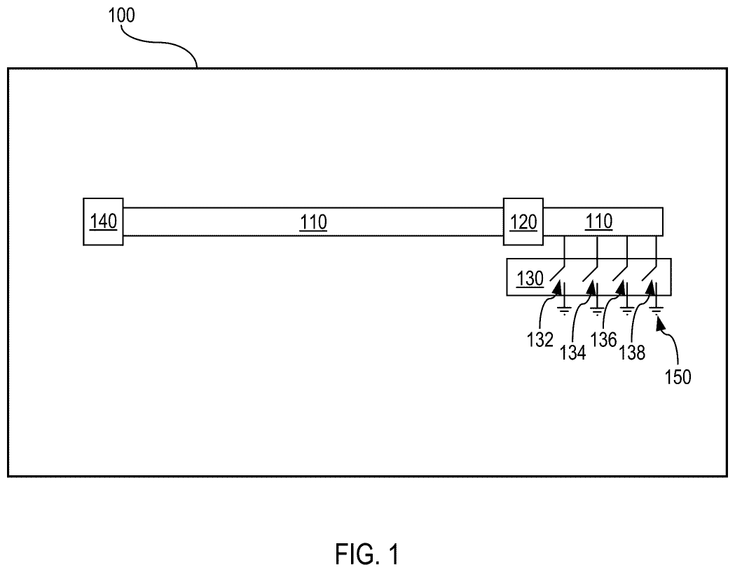

FIG. 1 illustrates an example antenna 110 with a switching apparatus 130, according to example embodiments of the present disclosure. In this example, the antenna 110 is part of a radio reading device 100 and is electrically connected to a load 120 of different impedance than a body of the antenna 110. A signal generator 140 is connected to an end of the antenna 110 opposite the load 120 and the switching apparatus 130. The switching apparatus 130 may provide a first path 132, a second path 134, a third path 136, and a fourth path 138 (collectively, the paths 132-138) to the electrical ground 150. The signal generator 140 applies an alternating voltage to the antenna 110 which induces an electrical field to detect and read radio devices in close proximity to the antenna 110. The load 120 may be selected to provide a desired standing wave amplitude. In some example embodiments, the load 120 may be excluded. In such embodiments, each of the paths 132-138 may include a load 120. Such a configuration may allow for dynamic selection of standing wave amplitude in conjunction with node position selection.

The switching apparatus 130 may include one or more transistors for selecting the first path 132, the second path 134, the third path 136, or the fourth path 138 respectively. Alternatively, the switching apparatus 130 may employ any other switching means to select a path of the paths 132-138, including but not limited to, mechanical relays and manual switches. The switching apparatus 130 may be configured to change a selected path of the paths 132-138 once per round of reading, where a round of reading may comprise a cycle in which the antenna 110 transmits, then the device 100 listens for a response. A single reading round may take, for example, around 50 milliseconds. By changing the selected path of the paths 132-138 during an inactive phase of the reading round in which neither transmission nor listening is occurring, effective switching by the switching apparatus 130 may be achieved with equipment with relatively low switching speeds and without concern for frequency distortions which might arise if switching were to occur during the transmitting phase.

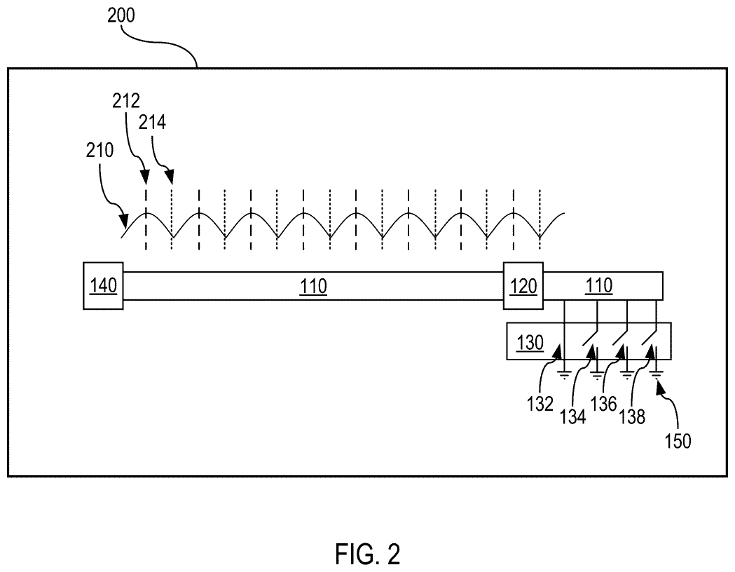

FIG. 2 illustrates the example antenna 110 and switching apparatus 130 in a first state 200, according to example embodiments of the present disclosure. In this example scenario, the first path 132 to the electrical ground 150 is selected by the switching apparatus 130 and a magnitude 210 of a standing wave propagating along the antenna 110 is shown, with maximums 212 and nodes 214 illustrated. Since each of these maximums 212 is constantly alternating between a high voltage and a low voltage, a polarity of each respective maximum 212 at any given moment in time is of no real consequence when reading radio devices and can be largely ignored. It can therefore be seen that the standing wave propagates as a series of maximums 212 separated by nodes 214. When attempting to read radio devices in the near field, a radio device positioned near one of the nodes 214 will be challenging to read due to the low electric field intensity present at the nodes 214. Conversely, a radio device positioned near one of the maximums 212 will be readily detected and read on account of the stronger electric field intensity present at the maximums 212. If the maximums 212 are too great, the electric field may project beyond the near field range and cause read events from radio devices which are located a significant distance (e.g. a distance greater than 16% of a wavelength of the standing wave) from the antenna 110.

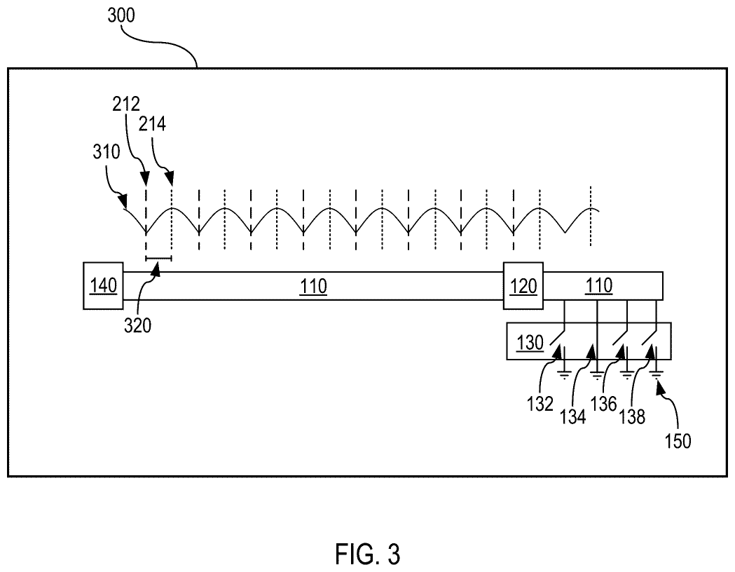

Individuals of skill in the art will appreciate that the wave as illustrated originates from the signal generator 140 and initially propagates down the antenna 110 from left to right as illustrated in FIG. 2. The wave is reflected by the load 120 and the first path 132 to the electrical ground 150, and interference between the initial wave and the reflected wave(s) forms the standing wave. The illustrated waveform is presented as an example and may not be representative of actual waveforms generated by embodiments of the present disclosure. The waveform in FIG. 2 and the waveforms of FIGS. 3, 4, 5, and 6 illustrate properties of standing waves in the context of the present disclosure and how technologies of the present disclosure manipulate the standing wave(s).

FIG. 3 illustrates the example antenna 110 and switching apparatus 130 in a second state 300, according to example embodiments of the present disclosure. In the second state 300, the second path 134 to the electrical ground 150 is selected by the switching apparatus 130. A magnitude plot 310 of a resulting waveform is illustrated, with the nodes 214 and maximums 212 of FIG. 2 superimposed on the magnitude 310. A distance 320 shows a shift in the standing wave to the right relative to FIG. 2, with the magnitude 310 having maximums where the nodes 214 were located in FIG. 2 and nodes where the maximums 212 were located in FIG. 2.

The magnitude 310 plot illustrated in FIG. 3 represents a phase shift of 90 degrees relative to the waveform illustrated in FIG. 2. Those of skill in the art will recognize that a system which alternates between the first state 200 (see FIG. 2) and the second state 300 will periodically shift the waveform left and right by a distance equivalent to the distance 320. This shifting means that no point along the antenna 110 is a permanent location of a node, and a device which toggles between the first state 200 and the second state 300 during the inactive phase of every reading round will be able to read radio devices along an entire length of the antenna 110.

Though utilizing two paths among the paths 132-138 may be a minimum to eliminate “dead spots” on the antenna 110, it may still be desirable to further smooth a field profile associated with the antenna 110 such that each point along the antenna 110 is surrounded by an electrical field of substantially equivalent intensity and projection distance. In such situations, three or four, paths among the paths 132-138 or more paths of the switching apparatus may be desirable to ensure consistent read behavior along the antenna 110. These additional paths 132-138 may be at phase offsets other than 90 degrees and may shift the standing wave by distances greater, less than, or equal to the distance 320. A magnitude of a phase shift of a given path may be determined by a distance 320 between a “zero phase offset path” and the given path. Specifically, the number of degrees in phase which the standing wave will be offset by a path may be equal to 360 divided by a ratio between a wavelength of the standing wave (a function of a frequency of the standing wave) and the distance 320. For example, a distance 320 which is equal to one quarter of a wavelength of the standing wave will result in a 90-degree phase offset.

It will be appreciated that one potential arrangement of the switching apparatus 130, for example, may be a first path 132 positioned at a zero degree phase shift (e.g. a reference phase from which subsequent phases are measured), a second path 134 positioned one-twelfth of a wavelength to the right of the first path 132 producing a 30 degree phase shift, a third path 136 positioned one-sixth of a wavelength to the right of the first path 132 producing a 60 degree phase shift, and additional paths positioned at one-twelfth wavelength intervals to produce additional 30 degree phase shifts until a shifted phase which overlaps with the zero-degree phase shift is encountered (which functionally occurs at the 180 degree phase shift at the sixth path). It will also be appreciated that irregular phase shift paths might be provided, for example with the second path 134 providing a phase shift of forty degrees relative to the first path 132, the third path 136 providing a phase shift of fifty-five degrees relative to the first path 132, and the fourth path 138 providing a phase shift of sixty degrees relative to the first path 132. This may enable fine control of electric field topologies to enable intentional differences in read distance along a length of the antenna 110.

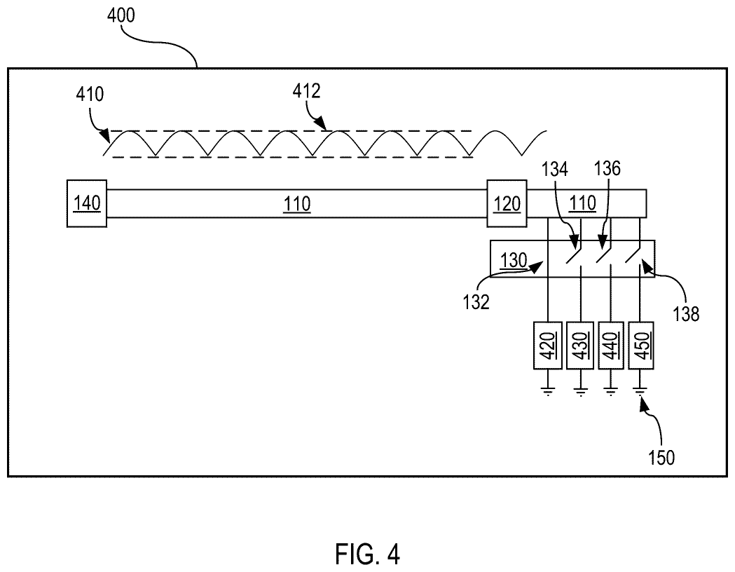

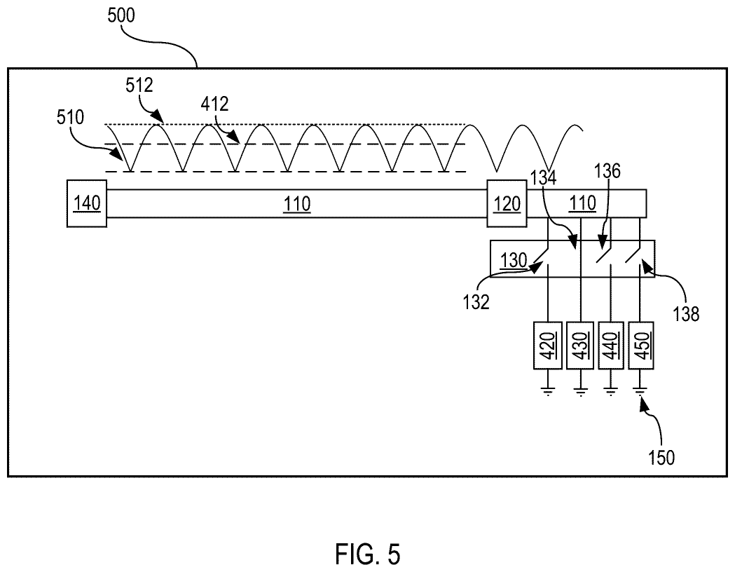

FIG. 4 illustrates the example antenna 110 and switching apparatus 130 with a first standing wave 410 of a first voltage amplitude 412, according to example embodiments of the present disclosure. In this example, the antenna 110 is in a first state 400. The first path 132 has a first secondary load 420, the second path 134 has a second secondary load 430, the third path 136 has a third secondary load 440, and the fourth path 138 has a fourth secondary load 450. In the example presented in FIG. 4 and FIG. 5, the first secondary load 420 has a lower impedance than the second secondary load 430. Though the antenna 110 is illustrated with the load 120, embodiments which include the first secondary load 420, the second secondary load 430, etc. may not include the load 120.

Furthermore, some embodiments may include the first secondary load 420 and the second secondary load 430 on switched branches of the first path 132, with the third secondary load 440 on the second path 134. Such an arrangement allows the switching apparatus 130 to vary an amplitude of the first standing wave 410 without changing the phase of the first standing wave 410. This may allow for a programmable switching apparatus 130 to be implemented. As such, a user may select and set a plurality of phases and amplitudes for the first standing wave 410 during a cycle of the switching apparatus 130 (which may comprise at least two reading rounds). Such an arrangement may also allow a user to specify a minimum and/or maximum electrical field magnitude along an entire length of the antenna 110 and subsequently determine and implement a switching solution via the switching apparatus 130 which meets the user's specified minimum and/or maximum electrical field magnitudes.

The load 120 may be of variable impedance. For example, the load 120 may include, but is not limited to, a variable capacitor, a variable inductor, a variable resistor, combinations thereof, or other devices which may provide a controllable impedance. The first secondary load 420, the second secondary load 430, the third secondary load 440, and the fourth secondary load 450 may also be of variable impedance, and such an arrangement may replace the branched switching arrangement described above.

FIG. 5 illustrates the example antenna 110 and switching apparatus 130 with a second standing wave 510 of a second voltage amplitude 512, according to example embodiments of the present disclosure. The first amplitude 412 from FIG. 4 is provided for comparison. Since the impedance of the second secondary load 430 is higher than that of the first secondary load 420, the second voltage amplitude 512 is larger than the first voltage amplitude 412. This property can be manipulated to create configurable field projection topologies wherein differing portions of the antenna 110 project the electric field by differing distances. Such a capability is useful when variable RFID tag sizes and spacing are encountered in a setting with multiple RFID tags (e.g. in an RFID printing environment). In this scenario, a field of the antenna 110 can be varied to accommodate a given label size and pitch while avoiding unwanted multiple reads or failures to read an intended tag.

It will be appreciated that while a magnitude of the standing wave can be pulled down to very low voltages with low impedance loads 120 and/or secondary loads 430, a practical limit to standing wave maximum amplitude exists in the form of the voltage which is applied by the signal generator 140. As such, a signal generator 140 (which is not capable of varying signal amplitude) may only transmit via the antenna 110 in a magnitude range which is less than or approximately equal to the supplied signal magnitude.

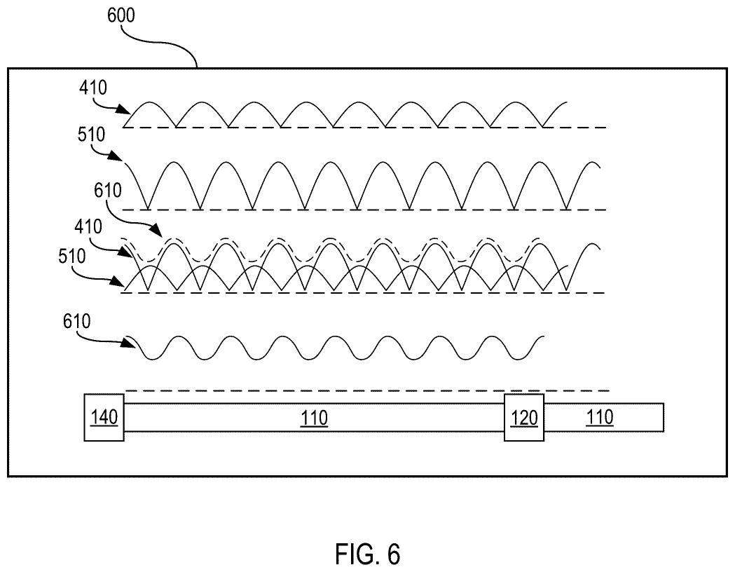

FIG. 6 is a diagram 600 which illustrates standing waves of FIG. 4 and FIG. 5 in addition to a composite wave 610, according to example embodiments of the present disclosure. Magnitudes of the first standing wave 410 and the second standing wave 510 are shown separately, and then superimposed with a composite wave 610. The composite wave 610 is shown separately. All waves of the diagram 600 are shown with voltage magnitude on a vertical axis and a position along the antenna 110 on the horizontal axis. The antenna 110 is provided for positional reference below the wave plots.

The composite wave 610 is representative of approximate maximum voltages along the length of the antenna 110 over a full switching cycle of the switching apparatus 130 (see FIGS. 1, 2, 3, 4, and 5). In this example, the antenna 110 is configured to project a variable-radius field across two reading rounds. such a field may be capable of reading radio devices at greater distances when the radio devices are placed in the peaks of the composite wave 610 than when the radio devices are placed in the troughs of the composite wave.

In various embodiments, the composite wave 610 may take drastically different forms than that of the illustrative example presented in the diagram 600. For example, embodiments which include a large number of paths (see FIG. 1) for the switching apparatus 130 to cycle through may produce a composite wave that resembles a flat line (e.g. a consistent maximum voltage across the antenna's length). Conversely, embodiments which, for example, include one path configured to produce a significantly larger amplitude than the others might produce a composite wave with large peaks periodically spaced along the antenna 110.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed:

1. A device, comprising:
an antenna;
an electrical load electrically connected to the antenna; and
a switching apparatus configured to vary an effective length of the antenna such that a standing wave propagating along the antenna is phase and position offset by a configurable amount when the switching apparatus is operated.

2. The device of claim 1, wherein the switching apparatus includes one or more paths to an electrical ground positioned at intervals along a length of the antenna on a side of the electrical load opposite to a source of the standing wave.

3. The device of claim 2, wherein each of the one or more paths to the electrical ground includes a secondary electrical load.

4. The device of claim 3, wherein a first secondary electrical load is configured with a different impedance than a second secondary electrical load.

5. The device of claim 1, wherein the electrical load is configured with a variable impedance.

6. The device of claim 1, wherein
the device is configured with a cyclical operation that includes an active period in which the standing wave is held constant and an inactive period in which an amplitude or phase of the standing wave is modified, and
the switching apparatus is configured to vary the effective length of the antenna during the inactive period.

7. The device of claim 1, wherein the device is configured to extract data from one or more radio frequency identification (RFID) tags.

8. The device of claim 7, wherein the device is configured to extract data from the one or more RFID tags at a distance equal to or less than 16% of a wavelength of the standing wave.

9. The device of claim 7, wherein the device is configured to extract data from the one or more RFID tags at a distance greater than or equal to 16% of a wavelength of the standing wave.

10. The device of claim 1, wherein the switching apparatus varies the effective length of the antenna such that the standing wave propagating along the antenna is phase and position offset such that points along the effective length of the antenna are subjected to an amplitude equal to or between a preselected minimum and maximum amplitude of the standing wave at least once during a full cycle of operation of the switching apparatus.

11. The device of claim 1, wherein the switching apparatus includes at least one field effect transistor.

12. A method, comprising:
applying an electrical signal to an electrically loaded antenna such that an electrical standing wave propagates along an effective length of the antenna;
providing, via a switching apparatus, a first path to an electrical ground along an effective length of the antenna such that the standing wave propagates at a first phase and position; and
providing, via the switching apparatus, a second path to the electrical ground along the effective length of the antenna such that the standing wave propagates at a second phase and position.

13. The method of claim 12, wherein the first path to the electrical ground and the second path to the electrical ground are positioned at a first location and a second location, respectively, along a length of the antenna on a side of the electrical load opposite to a source of the standing wave.

14. The method of claim 12, wherein each of the first path to the electrical ground and the second path to the electrical ground includes a secondary electrical load.

15. The method of claim 14, wherein a first secondary electrical load of the first path to the electrical ground is configured with a different impedance than a second secondary electrical load of the second path to the electrical ground.

16. The method of claim 12, wherein the electrical load is configured with a variable impedance.

17. The method of claim 12, further comprising:
designating an active period of a cycle of operation of the antenna in which the standing wave is held constant; and
designating an inactive period of a cycle of operation of the antenna in which an amplitude or phase of the standing wave is modified, during which the switching apparatus is configured to vary the effective length of the antenna.

18. The method of claim 12, further comprising extracting data from one or more radio frequency identification (RFID) tags.

19. The method of claim 18, further comprising extracting data from the one or more RFID tags at a distance equal to or less than 16% of a wavelength of the standing wave.

20. The method of claim 12, wherein the switching apparatus varies the effective length of the antenna such that the standing wave propagating along the antenna is phase and position offset such that points along the effective length of the antenna are subjected to an amplitude equal to or between a preselected minimum and maximum amplitude of the standing wave at least once during a full cycle of operation of the switching apparatus.

21. The method of claim 12, wherein the switching apparatus includes at least one field effect transistor.
